(19) United States
(12) Patent Application Publication
(10) Pub. No.: US 2024/0165812 A1
(43) Pub. Date: May 23, 2024

(54) SAFEGUARDED EXIT FROM PHYSICALLY CONSTRAINED ROBOTIC WORKSPACE

(71) Applicant: Dexterity, Inc., Redwood City, CA (US)

(72) Inventors: Tom Vardon, Niagara Falls (CA); Anmol Saiprasad Modur, Redwood City, CA (US); Robert Holmberg, Mountain View, CA (US); Vikas Agrawal, Santa Clara, CA (US)

(21) Appl. No.: 18/516,259

(22) Filed: Nov. 21, 2023

Related U.S. Application Data
(60) Provisional application No. 63/427,738, filed on Nov. 23, 2022.

(51) Int. Cl. B25J 9/16; B25J 13/08

(52) U.S. Cl. CPC B25J 9/1676; B25J 13/08

(57) ABSTRACT

A robotic system, method, and device for controlling operation of a robot is disclosed. The robotic system includes (i) a robot configured to move one or more items within a workspace, (ii) a sensor configured to collect sensor data with respect to the workspace, and (iii) one or more processors. The one or more processors are configured to (a) determine to reset operation of the robot, (b) determine, based at least in part on the sensor data, that a human worker exited a safeguarded space within the workspace, and (c) in response to determining that the human worker exited the safeguarded space, resume operation of the robot.

### CROSS REFERENCE TO OTHER APPLICATIONS

This application claims priority to U.S. Provisional Patent Application No. 63/427,738 entitled SAFEGUARDED EXIT FROM PHYSICALLY CONSTRAINED ROBOTIC WORKSPACE filed Nov. 23, 2022 which is incorporated herein by reference for all purposes.

### BACKGROUND OF THE INVENTION

Robots have been used to perform tasks in manufacturing and other fields. For example, robots have been used to perform tasks in environments that may be unhealthy or otherwise dangerous to humans, tasks that require the application of force greater than a human may be able to apply, and tasks that require a high degree of precision and consistency over time.

Robotic systems have been used to assemble kits, perform sortation and/or singulation, perform line kitting, and to stack items onto or remove items from a pallet or other receptacle.

Industrial robots are widely used in manufacturing environments to automate various tasks, increasing efficiency and productivity. However, the interaction between humans and robots in these settings poses inherent safety challenges, particularly during the start and restart phases of the robotic systems. Safety concerns associated with the deployment of industrial robots are of paramount importance, considering the proximity of human operators and the potential risks involved. Traditional safety measures often involve the use of physical barriers, emergency stop buttons, and light curtains to prevent accidents. While these measures mitigate some risks, they may not adequately address the complexities associated with the start and restart procedures of the robotic systems and may be costly to implement.

### BRIEF DESCRIPTION OF THE DRAWINGS

Various embodiments of the invention are disclosed in the following detailed description and the accompanying drawings.

FIG. 1 is a diagram illustrating a robotic system according to various embodiments.

FIG. 2 is a diagram illustrating a robotic system with a safeguarded space according to various embodiments.

FIG. 3A is a diagram illustrating a robotic system configured to resume operation based at least in part on detecting that a human worker has exited the safeguarded space according to various embodiments.

FIG. 3B is a diagram illustrating a robotic system configured to resume operation based at least in part on detecting that a human worker has exited the safeguarded space according to various embodiments.

FIG. 4 is a diagram illustrating a robotic system configured to resume operation based at least in part on detecting that a human worker has exited the safeguarded space according to various embodiments.

FIG. 5 is a flow diagram of a method for controlling to resume operation of a robot according to various embodiments.

FIG. 6 is a flow diagram of a method for determining whether conditions for resuming autonomous robot operation are satisfied according to various embodiments.

FIG. 7 is a flow diagram of a method for determining whether conditions for resuming autonomous robot operation are satisfied according to various embodiments.

FIG. 8 is a flow diagram of a method for controlling to resume operation of a robot according to various embodiments.

FIG. 9 is a flow diagram for controlling a robot to work in an autonomous mode according to various embodiments.

FIG. 10 is a flow diagram for controlling a robot to work in an autonomous mode according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a robotic system comprises a combination of hardware and software configured to perform a set of tasks, including a robot application (e.g., a robot that performs a particular function). As an example, the robot is deployed in the context of a robot application.

Related art systems in which a robot is deployed in an industrial robotic setting, a reset is required to be outside the safeguarded space, to enable a human to activate the reset from a position safely outside the safeguarded space.

Industrial Safety standards for working with robots in a non-collaborative space (i.e., not one in which robots and human work concurrently) require the robot to be in an enclosed or otherwise safeguarded space that ensures there is no access by a worker unless the robot(s) are stopped.

For an Autonomous Mobile Robot (AMR) operating in a confined space, such as a truck trailer, with no or unreliable or limited communications, the safety reset is unable to be placed outside the safeguarded space. Further, adding wireless communications from outside the safeguarded space may not be practical or economical and/or failure of such communications may result in down time. Conversely, systems in which a control unit is connected by the wire to the robot may not be practical.

Techniques are disclosed to reset a robotic system safely, without requiring wired or wireless communications with the robotic system from outside the safeguarded space. In various embodiments, a reset button or other manually activated control is provided, for example, on or near the robot. A human activates the reset. Safety (e.g., laser) scanner fields or other safety rated scanning/monitoring structures or devices are used to detect that the human has exited from the safeguarded space, or otherwise determine when the safeguarded space is free of any humans. The robotic system resumes operation based on an indication that the human has been determined to have exited from the safeguarded space after having activated the reset button or other manually operated control.

In some embodiments, the reset button is within the safeguarded space, for example, on the robot or within proximity of the robot. In traditional installations, and currently required by existing consensus standards, the reset typically would be outside the safeguarded space. Various other related art installations may include a reset button within the safeguarded space; however, such systems start a predefined timer upon the reset button being pressed, and the human is required to press a second button outside the safeguarded space within a predefined time counted by the timer.

As disclosed herein, the scanner field is used to allow the reset to be inside the safeguarded space, and yet be compliant with safety standards or other requirements. The scanner field may comprise one or more fields of detection for which a sensor system captures data, and the system detects humans and/or determines whether humans move out of the safeguarded space or a sufficient distance outside the safeguarded space. As an example, the scanner field comprises a first field of detection and a second field of detection. The first field of detection and the second field of detection may be at least partially overlapping. In some embodiments, the system uses sensor data captured for each of the first field of detection and the second field of detection in connection with determining that the human has left the safeguarded space.

Various embodiments provide a robotic system, method, and device for controlling operation of a robot is disclosed. The robotic system includes (i) a robot configured to move one or more items within a workspace, (ii) a sensor configured to collect sensor data with respect to the workspace, and (iii) one or more processors. The one or more processors are configured to (a) determine to reset operation of the robotic arm, (b) determine, based at least in part on the sensor data, that a human worker exited a safeguarded space within the workspace, and (c) in response to determining that the human worker exited the safeguarded space, resume operation of the robot.

In some embodiments, multiple safety scanner fields may be defined and used to follow the approach of a person to a hazard, such as an operating robot, to slow or stop the hazard as the person gets nearer. In some embodiments, the same fields may be repurposed to implement the reset techniques disclosed herein.

In some embodiments, the system determines whether a human worker entered a field of detection based on a determination that a state for the field of detection switched from a no-human present state to a human present state. Conversely, the system determines that the human exited the field of detection based on a determination that a state for the field of detection switched from a human present state to a no-human present state.

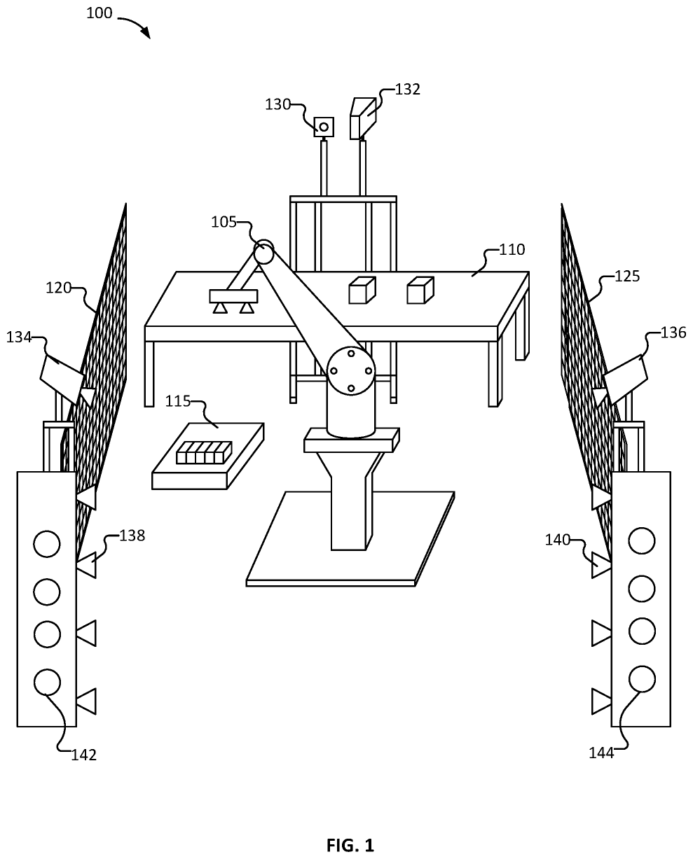

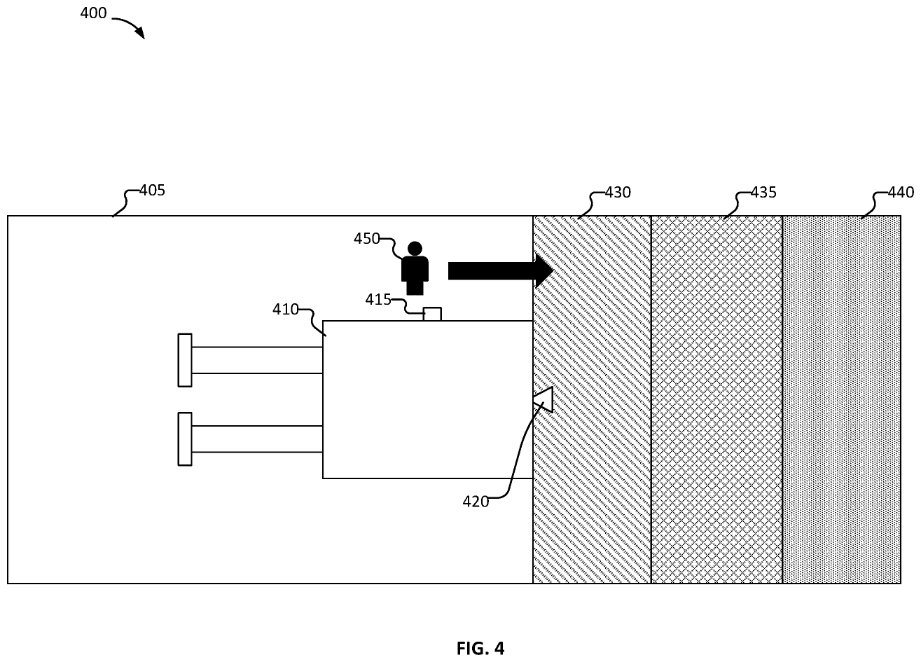

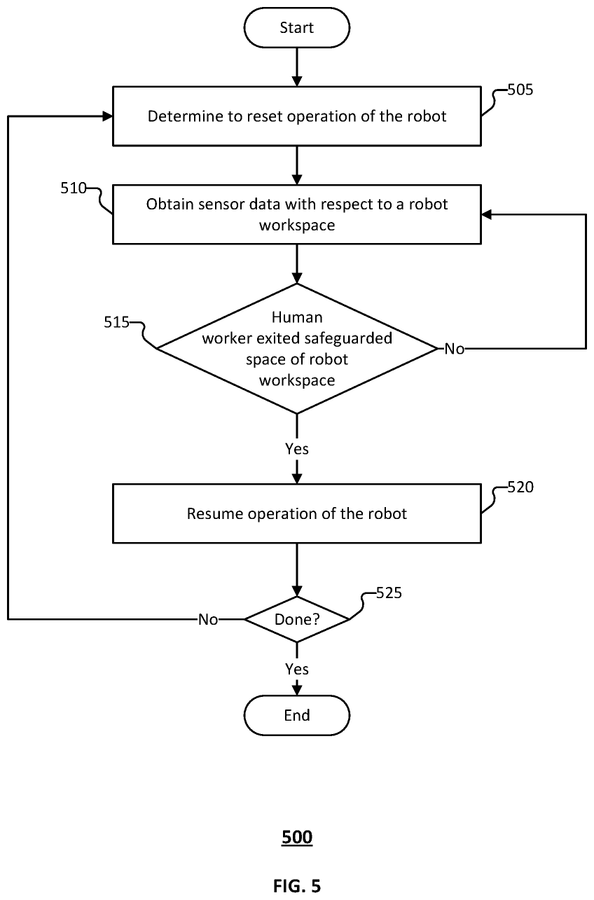

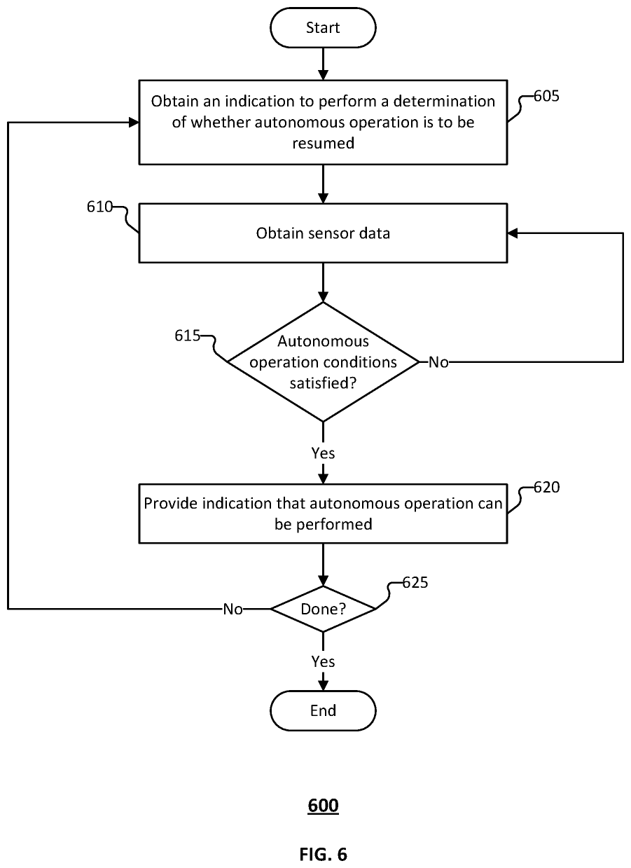

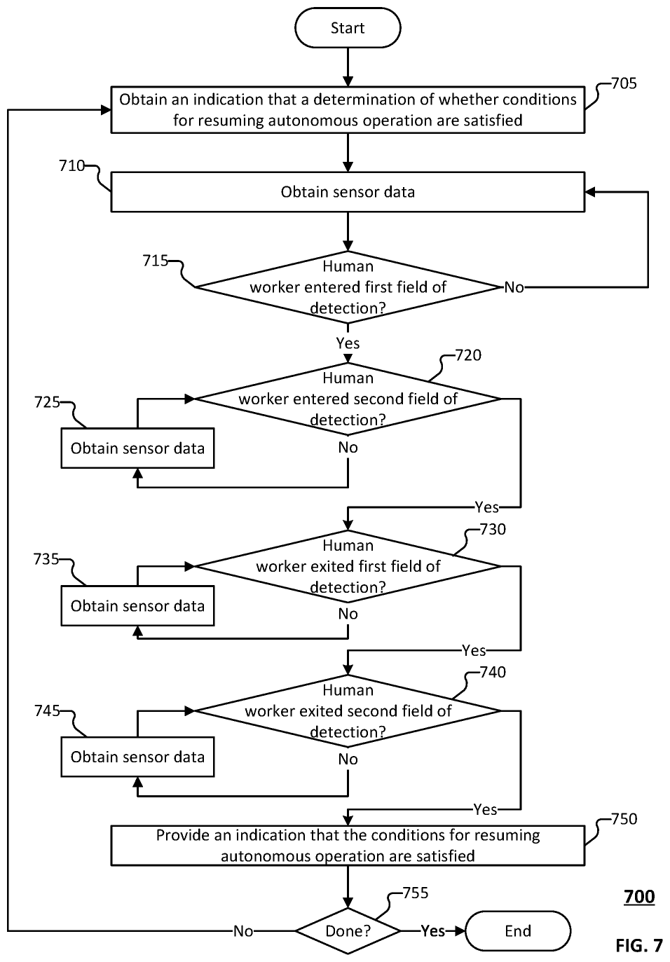

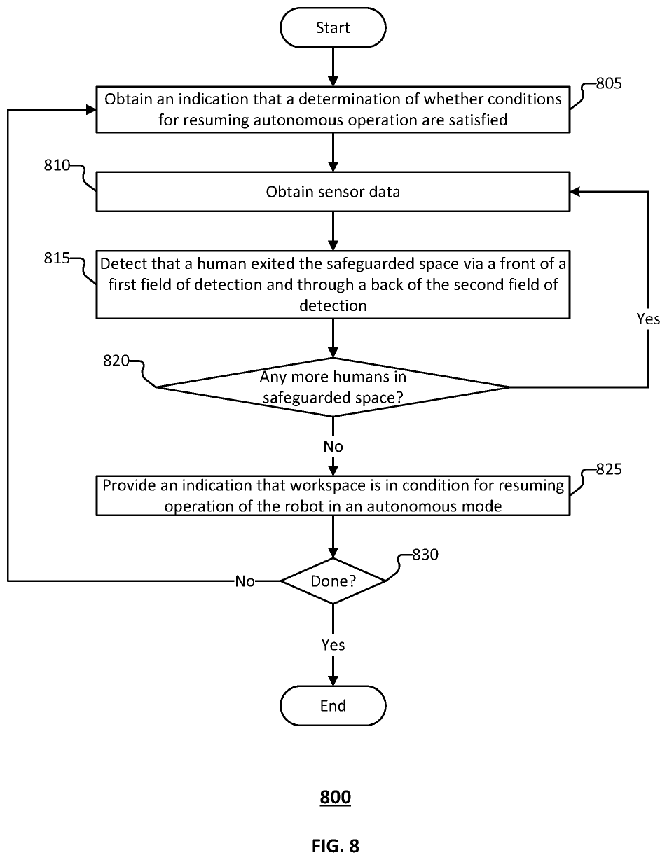

FIG. 1 is a diagram illustrating a robotic system according to various embodiments. In some embodiments, system 100 implements at least part of process 400 of FIG. 4, process 500 of FIG. 5, process 600 of FIG. 6, process 700 of FIG. 7, and/or process 800 of FIG. 8.

In various embodiments, once the robot has been stopped, e.g., upon detecting approach of a human worker, to resume operation the system requires that the reset button or other manually operated control be activated, and that the human worker be detected to have left the safeguarded space. The human may be trained and required to ensure, prior to activating the reset control, that no other humans or other hazards are present in the safeguarded space, and to exit the space slowly, e.g., within a prescribed time of activating the reset. The system may detect the human has entered a first field near the robot, then a second field further from the robot, at least in part, then the first, then exited the first field followed by exiting the second field, which extends further from the robot than the first field, after which autonomous operation of the robot resumes.

In the example shown, system 100 comprises robot 105 deployed in a workspace. The workspace may be constrained/enclosed such as by walls 120, 125. Within the workspace, robot 105 may be controlled to perform tasks with respect to items within the workspace. Various tasks may be performed. For example, various types of systems may be deployed, such as a singulation system for performing singulation tasks, a kitting system for performing kitting tasks, and/or a palletization system for performing palletizing tasks.

As illustrated, robot 105 is controlled to palletize items to pallet 115. For example, robot 105 picks items from a source location, such as table 110, a conveyor, shelf, etc. Robot 105 is controlled to perform the tasks in an autonomous mode (e.g., in the absence of human intervention except when the system is to be reset or reconfigured). Robot 105 may be controlled by a control system (not shown). System 100 comprises a sensor system that system 100 uses to collect sensor data pertaining to the workspace.

In some embodiments, the sensor system comprises one or more 2D cameras, 3D (e.g., RGBD) cameras, infrared sensors, light curtains, and other sensors. System 100 uses sensor data captured by the sensor system to generate a three-dimensional view of a workspace (or part of a workspace such as a pallet and stack of items on the pallet). System 100 can use the sensor data to generate a model for a safeguarded space which may correspond to, comprise, or be comprised in the workspace. The safeguarded space may be a space for which the presence of a human worker impacts whether robot 105 is operated in an autonomous mode. For example, when a human worker is not in the safeguarded space, robot 105 is free to operate autonomously to perform the tasks with respect to items in the workspace. The control system uses the sensor data for the safeguarded space to detect the presence of a human. In response to determining that a human worker is within the safeguarded space, the control system causes robot 105 to pause or otherwise cease operation in autonomous mode. The control system can monitor the safeguarded space and cause robot 105 to resume operation in autonomous mode in response to detecting that the human worker has left the safeguarded space, or in response to determining that no human workers remain in the safeguarded space. System 100 can further use the sensor data to monitor the movement/location of human workers.

In the example shown, the sensor system comprises cameras 130, 132, 134, and 136. The sensor system further comprises sensors such as 138, 140, 142, and/or 144 which can be used to detect when a human worker enters the safeguarded space in which robot 105 operates (e.g., in a constrained space such as a space defined by walls 120, 125, or a space such as a trailer during loading/unloading, etc.). As an example, sensors 138 and 140 may be sensors comprised in a light curtain.

In some embodiments, the sensor system comprises a sensor(s) to detect human workers in the fields of detection. A single sensor can be used to detect the human worker in a set of successive fields of detection. For example, a multi-field sensor is used to detect movement of the human field through a plurality of the set of fields of detection. In some embodiments the sensor(s) configured to collect sensor data for various fields of detection have a refresh rate equal to or less than 200 ms.

In some embodiments, the sensor system comprises one or more active or passive sensors configured to obtain sensor data with respect to a set of fields of detection (e.g., a set of successive fields of detection). As an example, the sensor comprises a transponder and receiver to obtain sensor data pertaining to a field of detection.

According to various embodiments, the system enables robot 105 to resume autonomous operation in response to determining that a reset control has been activated, and following activation of the reset control, that all human workers have left the safeguarded space. The reset control may be a reset button or other control that is disposed on robot 105 or in proximity to robot 105. The system may determine that all human workers have left the safeguarded space by monitoring a first field of detection and a second field of detection and detecting the movement of the human worker(s) through the first field of detection to the second field of detection, and out of the back of the second field of detection (e.g., a distal end of the second field of detection relative to robot 105). The system may deem the human worker to have exited the safeguarded space upon exiting the second field of detection (e.g., without re-entering the first field of detection).

The safety start and restart mechanism of various embodiments enhances overall safety by addressing the critical phases of robot operation, reducing the likelihood of accidents and injuries during startup and restart procedures.

In some embodiments, system 100 adapts to dynamic changes in the environment, ensuring that the robot is started or restarted under conditions that minimize risks and optimize operational efficiency. The incorporation of real-time monitoring capabilities enables system 100 to respond promptly to unforeseen circumstances, providing a proactive approach to safety during critical operational phases. The fail-safe mechanisms of system 100 (e.g., the pausing or deactivating the operation of robot 105 in autonomous operation) contribute to minimizing downtime by swiftly halting operations in the presence of potential risks, allowing for efficient troubleshooting and resolution.

In some embodiments, the system disables the autonomous operation of a robot upon detecting the presence of a human within a safeguarded space. The system uses sensor data collected by a plurality of sensors and real-time detection algorithms (e.g., the system generates a model of the safeguarded space and/or fields of detection to monitor movement of humans) to identifies the intrusion of a human worker into a designated field of detection (e.g., a safeguarded space), triggering an immediate suspension of autonomous robotic functions to prevent potential collisions or accidents. Following this safeguarded state, various embodiments incorporate a reset control within the safeguarded space, which, when activated, initiates a systematic reevaluation of the environment. Once the system detects a human worker entering a first field of detection (e.g., enters the front/proximal portion of the first field of detection), moving into a second field of detection, and subsequently exiting the second field of detection (e.g., via a back of the second field of detection), it intelligently resumes autonomous operation, ensuring a seamless and safe integration of robotic tasks with human activities. This safety protocol not only prioritizes the well-being of human workers but also facilitates the efficient and secure collaboration between humans and robots in industrialized settings.

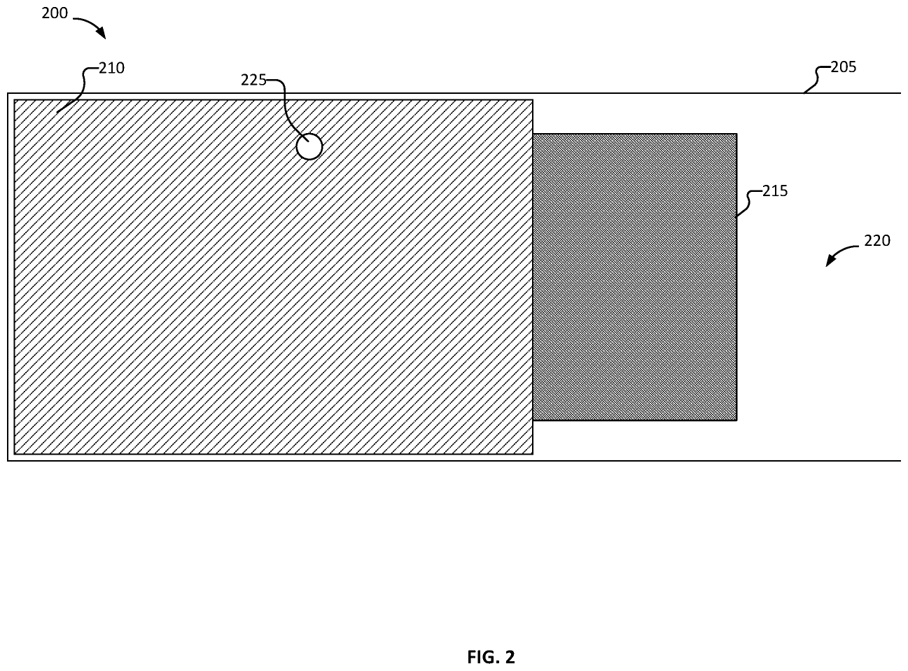

FIG. 2 is a diagram illustrating a robotic system with a safeguarded space according to various embodiments. In some embodiments, system 200 implements at least part of process 400 of FIG. 4, process 500 of FIG. 5, process 600 of FIG. 6, process 700 of FIG. 7, and/or process 800 of FIG. 8.

In the example shown, system 300 comprises three solid walls 205 (e.g., walls for a shipping trailer/container) and an open wall that is protected by the safety field of a scanner, thereby creating the safeguarded space 210. System 200 uses sensor data to detect when a human worker has exited safeguarded space 210 and scanner field 215, such as to move to the back of the trailer 220 adjacent to the open wall. In some embodiments, scanner field 215 and safeguarded space 210 are at least partially overlapping. For example, safeguarded space 210 may comprise scanner field 215.

System 200 prevents autonomous operation of a robot upon detection of a human worker in safeguarded space 210. To resume autonomous operation, a predefined protocol is performed. For example, the system only enables autonomous operation upon completion of the predefined protocol. In some embodiments, the predefined protocol comprises (i) reset control 225 within safeguarded space 210 being activated, such as by the human worker, and (ii) for one or more human workers (e.g., for all human workers)in safeguarded space 210, (a) the human worker entering a first field of detection in scanner field 215, (b) the human worker entering a second field of detection in scanner field 215, and (c) the human worker exiting the second field of detection (e.g., to enter the back of the trailer 220). The predefined protocol may further comprise detection that the human worker exits the second field of detection before exiting the second field of detection, and preferably, after having entered the second field of detection in the case that the first field of detection and the second field of detection are at least partially overlapping

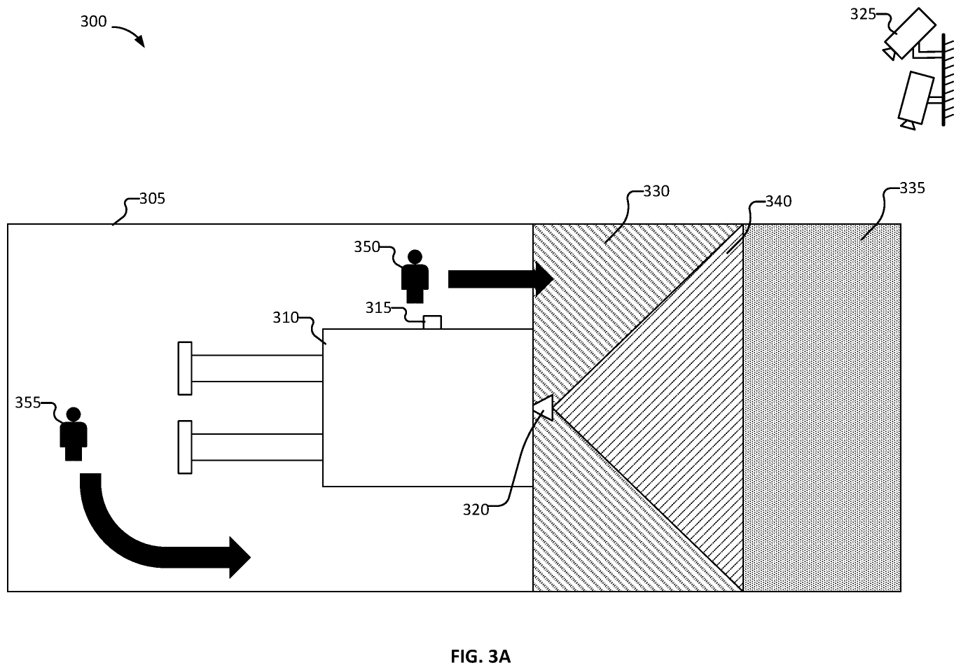

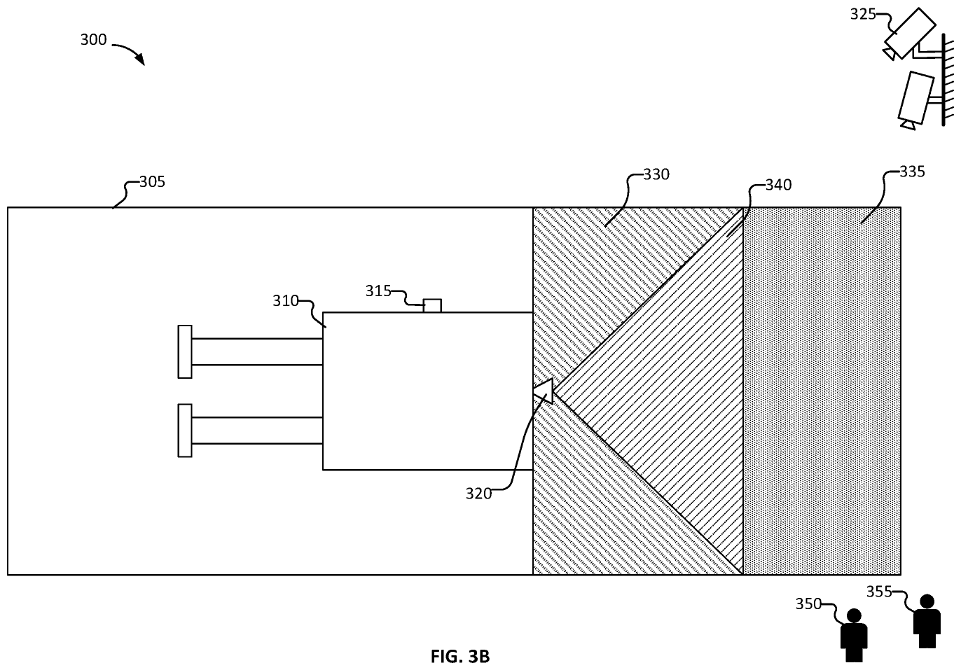

FIGS. 3A and 3B is a diagram illustrating a robotic system configured to resume operation based at least in part on detecting that a human worker has exited the safeguarded space. In some embodiments, system 200 implements at least part of process 400 of FIG. 4, process 500 of FIG. 5, process 600 of FIG. 6, process 700 of FIG. 7, and/or process 800 of FIG. 8.

To activate the robot and resume autonomous mode, the human worker checks and ensures trailer (e.g., the safeguarded space) is clear, e.g., of other workers or other hazards, activates the reset control (e.g., presses the reset button, which may be within the safeguarded space), and walks (e.g., slowly) out of the trailer. The fields are used to invisibly monitor the human worker as the human worker leaves, and the system activates the robot and/or resume operation in autonomous mode once the worker has exited the safeguarded space. For example, the system enables the robot to resume operation in autonomous mode. In some embodiments, the system controls to generate a short sound and/or a flashing light within the workspace before the robot resumes autonomous operation.

In the example shown, system 300 comprises a constrained space such as trailer 305. System 300 further comprises robot 310 which is configured to autonomously perform tasks within the constrained space, such as to load/unload items to/from trailer 305.

In some embodiments, system 300 comprises a reset control, such as reset button 315. The reset control may be disposed in the safeguarded space and activated by a human worker (e.g., human 350) when the human worker is within the safeguarded space. For example, human 350 may press reset button 315. In some embodiments, activation of the reset control initiates a protocol in which the system monitors the workspace (e.g., the safeguarded space) and determines whether all human workers have exited the safeguarded space. Upon determining that no further humans are in the safeguarded space, system 300 enables robot 310 to resume autonomous operation.

System 300 further comprises a sensor system, which in the example shown includes sensor(s) 320 and/or cameras 325. The sensor system collects sensor data pertaining to the safeguarded space. For example, as shown, sensor(s) 320 collects sensor data for first field of detection 330 and second field of detection 335. In some embodiments, first field of detection 330 and second field of detection 335 are at least partially overlapping, such as designed by overlapping area 340.

After activating the reset control (e.g., pressing reset button 315), humans 350 and 355 exit the safeguarded space, as shown in FIG. 3B.

The system implements the protocol for monitoring the exiting of humans from the safeguarded space in response to activation of the reset control. After the reset control is activated, system 300 uses sensor data (e.g., collected by sensor(s) 320) to determine whether all humans have exited the safeguarded space, such as based on detection that the humans enter first field of detection 330, then enter second field of detection 335 (e.g., such as in overlapping area 340), then exit the first field of detection 330 (e.g., so the human is in the non-overlapping portion of second field of detection), and then exit the second field of detection 335 (e.g., via the back of the second field of detection 335, such as by leaving the trailer of constrained space).

The description of the example shown in FIGS. 3A and 3B is in the context of a set of fields of detection that are overlapping. In other embodiments, the set of fields of detection may be non-overlapping. For example, the system comprises a set of successive fields of detection (e.g., two or more successive fields that do not overlap).

FIG. 4 is a diagram illustrating a robotic system configured to resume operation based at least in part on detecting that a human worker has exited the safeguarded space according to various embodiments.

To activate the robot and resume autonomous mode, the human worker checks and ensures trailer (e.g., the safeguarded space) is clear, e.g., of other workers or other hazards, activates the reset control (e.g., presses the reset button, which may be within the safeguarded space), and walks (e.g., slowly) out of the trailer. The fields are used to invisibly monitor the human worker as the human worker leaves, and the system activates robot and/or resume operation in autonomous mode once the human worker has exited the safeguarded space. The system may determine that the human worker has exited the safeguarded space based at least in part on a determination that the human worker is in a designated exit zone.

In some embodiments, the system has a plurality of successive fields of detection. The successive fields of detection are respectively distanced successively further from the robot. For example, in the event that the system has three successive fields of detection, a first field of detection is a field of detection that is closest to the robot, a second field of detection is second closest to the robot (e.g., the second field of detection is adjacent to the first field of detection), a third field of detection is third closest to the robot (or furthest from the robot). In some embodiments, none of the plurality of successive fields of detection overlap with one another. N some embodiments, two or more of the successive fields of detection overlap with another field of detection.

In the example shown, system 400 comprises a constrained space such as trailer 405. System 400 further comprises robot 410 which is configured to autonomously perform tasks within the constrained space, such as to load/unload items to/from trailer 405.

In some embodiments, system 400 comprises a reset control, such as reset button 415. The reset control may be disposed in the safeguarded space and activated by a human worker (e.g., human 450) when the human worker is within the safeguarded space. For example, human 450 may press reset button 415. In some embodiments, activation of the reset control initiates a protocol in which the system monitors the workspace (e.g., the safeguarded space) and determines whether all human workers have exited the safeguarded space. Upon determining that no further humans are in the safeguarded space, system 400 enables robot 410 to resume autonomous operation.

The human worker that presses the reset button is the last person in the safeguarded space. For example, human workers may be trained to check the safeguarded space to confirm that no other human workers or objects that could disrupt the robot are within the safeguarded space. In some embodiments, the system comprises a sensor system (e.g., cameras, etc.) to detect the human workers within the safeguarded space. In response to receiving an indication that the reset control is activated, the system may confirm that the safeguarded space only has a single human worker therein (e.g., the human worker that pressed the reset control button within the safeguarded space).

System 400 further comprises a sensor system, which in the example shown includes sensor 420. The sensor system collects sensor data pertaining to the safeguarded space. In the example shown, sensor 420 collects sensor data for first field of detection 430, second field of detection 435, and third field of detection 440. In some embodiments, first field of detection 430, second field of detection 435, and third field of detection 440 are non-overlapping.

The sensor data collected by sensor 420 can be used to detect that a human worker is exiting the safeguarded space, or a field of detection based on system 400 determining that the human worker is moving in a manner that successively moves across the successive fields of detection.

In some embodiments, sensor 420 is a multi-field sensor. A single sensor 420 may be used to collect sensor data for (e.g., detect a human within) first field of detection 430, second field of detection 435, and third field of detection 440. Sensor 420 can be implemented as a passive or an active sensor. System 400 may confirm that the human worker has exited the safeguarded space based on determining, based on the sensor data, that the human worker is in a designated exit zone. The designated exit zone may be a predefined space outside the safeguarded space. Referring to the example shown, the designated exit zone may be a space that is further from the robot than third field of detection 440.

In alternative embodiments, two or more of first field of detection 430, second field of detection 435, and third field of detection 440 are overlapping.

After activating the reset control (e.g., pressing reset button 415), human worker 450 exits the safeguarded space, such as by moving through the successive fields of detection.

In some embodiments, system 400 implements the protocol for monitoring the exiting of humans from the safeguarded space in response to activation of the reset control. After the reset control is activated (e.g., by the last remaining human in the safeguarded space), system 400 uses sensor data (e.g., collected by sensor 420) to determine whether all humans have exited the safeguarded space, such as based on detection that the human worker successively moves through the fields of detection. For example, system 400 uses the sensor data 420 to determine that the human worker has exited first field of detection 430 (e.g., the field of detection closest to robot 410), then exits second field of detection 435 (e.g., a field of detection next closest to robot 410), then exit the first field of detection 330 (e.g., so the human is in the non-overlapping portion of second field of detection), and then exit the second field of detection 435 (e.g., via the back of the second field of detection 435), and then exit the third field of detection 440 (e.g., such as by leaving the trailer of constrained space and entering into a designated exit).

FIG. 500 is a flow diagram of a method for controlling to resume operation of a robot according to various embodiments. In some embodiments, process 500 is implemented at least in part by system 100 of FIG. 1 and/or system 300 of FIGS. 3A and 3B.

At 505, the system determines to reset operation of the robot. In some embodiments, the system determines to reset operation of the robot in response to determining that a reset control has been activated, such as by detecting that a reset button in the safeguarded space is pressed.

At 510, the system obtains sensor data with respect to a robot workspace. The system collects sensor data for the safeguarded space. The sensor data may comprise data for one or more fields of detection. The one or more fields of detection may be monitored to verify that the human worker(s) exited the safeguarded space.

At 515, the system determines whether the human worker(s) have exited the safeguarded space of the robot workspace. In some embodiments, the system analyzes the sensor data for one or more fields of detection in connection with determining whether the human worker has exited the safeguarded space. At 515, the system may invoke process 700 of FIG. 7 or process 800 of FIG. 8.

In response to determining that the human worker(s) (e.g., all human workers) have not exited the safeguarded space, process 500 returns to 510 and process 500 iterates over 510-515 until no further humans (e.g., including any humans that may have entered the safeguarded space since the reset control was activated) are in the safeguarded space. Conversely, in response to determining that the human worker(s) have exited the safeguarded space, process 500 proceeds to 500.

At 520, the system resumes operation of the robot. For example, in response to determining that the safeguarded space is clear of all humans, the system enables (e.g., configures, permits, etc.) the robot to operate in autonomous mode to perform corresponding tasks in the workspace (e.g., performing singulation, palletization, or kitting of items).

At 525, a determination is made as to whether process 500 is complete. In some embodiments, process 500 is determined to be complete in response to a determination that no further robotic systems are to be monitored/controlled, the robot has completed its set of tasks in autonomous operation, a user has stopped the robot operation, an administrator or other user indicates that process 500 is to be paused or stopped, etc. In response to a determination that process 500 is complete, process 500 ends. In response to a determination that process 500 is not complete, process 500 returns to 505.

FIG. 6 is a flow diagram of a method for determining whether conditions for resuming autonomous robot operation are satisfied according to various embodiments. In some embodiments, process 600 is implemented at least in part by system 100 of FIG. 1 and/or system 300 of FIGS. 3A and 3B.

At 605, the system obtains an indication to perform a determination of whether an autonomous operation is to be performed. In some embodiments, the system indication to perform the determination of whether the autonomous operation is to be performed (e.g., continued/resumed) corresponds to, or is generated in response to, the reset control being activated.

At 610, the system obtains sensor data. The obtaining sensor data may comprise obtaining sensor data for a plurality of fields of detection, which can be monitored to detect the presence/movement of human workers.

At 615, the system determines whether a set of autonomous operation conditions are satisfied. The set of autonomous operations may be predefined. For example, the set of operations may correspond to a protocol that is to be performed before autonomous operation is to be resumed. In some embodiments, the system invokes process 700 or process 800.

In response to determining that the set of autonomous operation conditions are not satisfied, process 600 returns to 610 and process iterates over 610-615 until the set of autonomous operation conditions are satisfied. For example, the system continues to monitor (e.g., collect sensor data) for the safeguarded space and determine whether the safeguarded space is free of humans. Conversely, if the system determines that the set of autonomous operation conditions are satisfied, process 600 proceeds to 620.

At 620, the system provides an indication that autonomous operation can be performed. For example, the system provides the indication to another system, service, or process that invoked process 600. The system may provide the indication to a control system that controls the robot to autonomously perform a set of tasks.

At 625, a determination is made as to whether process 600 is complete. In some embodiments, process 600 is determined to be complete in response to a determination that no further robotic systems are to be monitored/controlled, the robot has completed its set of tasks in autonomous operation, a user has stopped the robot operation, an administrator or other user indicates that process 600 is to be paused or stopped, etc. In response to a determination that process 600 is complete, process 600 ends. In response to a determination that process 600 is not complete, process 600 returns to 605.

FIG. 6 is a flow diagram of a method for determining whether conditions for resuming autonomous robot operation are satisfied according to various embodiments. In some embodiments, process 700 is implemented at least in part by system 100 of FIG. 1 and/or system 300 of FIGS. 3A and 3B.

In some embodiments, process 700 provides a protocol that is to be performed/satisfied in order to enable/control the robot to operate in the autonomous mode. Process 700 may be performed with respect to each human worker that is detected to have entered the safeguarded space.

At 705, the system obtains an indication that a determination of whether conditions for resuming autonomous operation are satisfied. For example, process 700 is invoked via 615 of process 600.

At 710, the system obtains sensor data.

At 715, the system determines whether a human worker entered a first field of detection, such as based on the sensor data for the first field of detection. In response to determining that the human worker has not entered the first field of detection, process 700 returns to 710 and process 700 iterates over 710-715 until the system determines that the human worker entered the first field of detection. Conversely, in response to determining that the human worker entered the first field of detection, process 720 proceeds to 720.

At 720, the system determines whether a human worker entered a second field of detection, such as based on the sensor data for the second field of detection. The second field of detection may overlap with the first field of detection so that a user does not necessarily have to have exited the first field of detection before entering the second field of detection. In response to determining that the human worker has not entered the second field of detection, process 700 proceeds to 725 at which the system obtains sensor data and process 700 iterates over 720-725 until the system determines that the human worker entered the second field of detection. Conversely, in response to determining that the human worker entered the second field of detection, process 700 proceeds to 730.

At 730, the system determines whether a human worker exited the first field of detection, such as based on the sensor data for the first field of detection. In response to determining that the human worker has not exited the first field of detection, process 700 proceeds to 735 at which the system obtains sensor data and process 700 iterates over 730-735 until the system determines that the human worker exited the first field of detection. Conversely, in response to determining that the human worker exited the first field of detection, process 700 proceeds to 740.

At 740, the system determines whether a human worker exited the second field of detection, such as based on the sensor data for the second field of detection. In response to determining that the human worker has not exited the second field of detection, process 700 proceeds to 745 at which the system obtains sensor data and process 700 iterates over 740-745 until the system determines that the human worker exited the second field of detection. Conversely, in response to determining that the human worker exited the second field of detection, process 700 proceeds to 750.

At 650, the system provides an indication that conditions for resuming autonomous operation are satisfied. For example, the system provides the indication to another system, service, or process that invoked process 700. The system may provide the indication to a control system that controls the robot to autonomously perform a set of tasks.

At 755, a determination is made as to whether process 700 is complete. In some embodiments, process 700 is determined to be complete in response to a determination that no further robotic systems are to be deployed or configured, no further safety systems are to be configured or calibrated, that the robotic system being deployed is successfully configured, an administrator or other user indicates that process 700 is to be paused or stopped, etc. In response to a determination that process 700 is complete, process 700 ends. In response to a determination that process 700 is not complete, process 700 returns to 705.

FIG. 8 is a flow diagram of a method for controlling to resume operation of a robot according to various embodiments. In some embodiments, process 800 is implemented at least in part by system 100 of FIG. 1 and/or system 300 of FIGS. 3A and 3B.

At 805, the system obtains an indication that a determination of whether conditions for resuming autonomous operation are satisfied. For example, process 700 is invoked via 615 of process 600. At 810, the system obtains sensor data. At 815, the system detects that a human exited the safeguarded space via a front of a first field of detection and through a back of the second field of detection. At 820, the system determines whether any more humans are in the safeguarded space. In response to determining that one or more other humans are in the safeguarded space, process 800 returns to 810 and process 800 iterates over 810-820 until no further humans are in the safeguarded space. Conversely, in response to determining that no further humans are in the safeguarded space, process 800 proceeds to 825. At 825, the system provides an indication that the workspace is in condition for resuming operation of the robot in an autonomous mode. For example, the system provides the indication to another system, service, or process that invoked process 800. The system may provide the indication to a control system that controls the robot to autonomously perform a set of tasks. At 830, a determination is made as to whether process 800 is complete. In some embodiments, process 800 is determined to be complete in response to a determination that no further robotic systems are to be monitored/controlled, the robot has completed its set of tasks in autonomous operation, a user has stopped the robot operation, an administrator or other user indicates that process 800 is to be paused or stopped, etc. In response to a determination that process 800 is complete, process 800 ends. In response to a determination that process 800 is not complete, process 800 returns to 805.

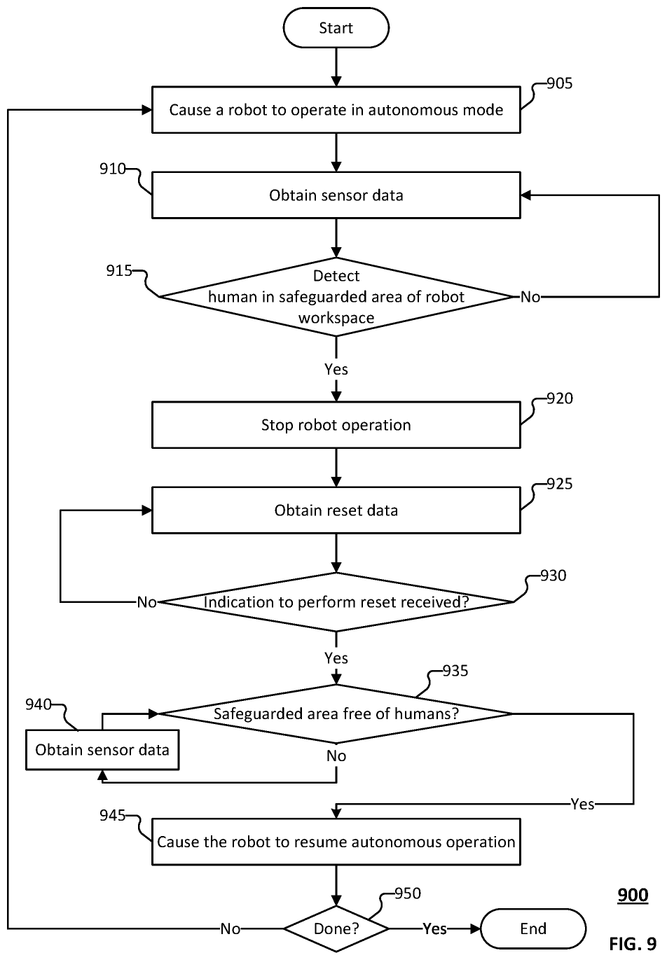

FIG. 9 is a flow diagram for controlling a robot to work in an autonomous mode according to various embodiments. In some embodiments, process 900 is implemented at least in part by system 100 of FIG. 1 and/or system 300 of FIGS. 3A and 3B.

At 905, the system causes a robot to operate in an autonomous mode.

At 910, the system obtains sensor data. The system obtains the sensor data from a sensor system comprising a plurality of sensors configured detect info for workspace. In some embodiments, the sensor system comprises a first subset for obtaining sensor data for a first field of detection, and a second subset for second field of detection. The first field of detection and the second field of detection may be at least partially overlapping.

At 915, the system determines whether a human in a safeguarded space of the robot workspace is detected.

In response to determining that a human is not detected in the safeguarded space, process 900 returns to 910 and process 900 iterates over 910-915 until the system detects a human in the safeguarded space. As process 900 iterates over 910-915, the robot may continue to operate in autonomous mode. In response to determining that a human is detected in the safeguarded space, process 900 proceeds to 920.

At 920, the system stops operation of the robot.

At 925, the system obtains reset data. In some embodiments, the reset data comprises data indicating whether a reset control has been activated. For example, the reset data may be generated in response to a reset button being pressed, or other such reset control being activated. The system may monitor for a receipt of reset data.

At 930, the system determines whether an indication to perform a reset is received. In response to determining that the indication to perform the reset is not received, process 900 returns to 925 and process 900 iterates over 925-930 until the system determines that the indication to perform the reset is received. Conversely, in response to determining that the indication to perform the reset is received, process 900 proceeds to 935.

At 935, the system determines whether the safeguarded space is free of humans. For example, the system determines whether a human(s) exited the safeguarded space, such as after the reset control (e.g., reset button) is activated.

In response to determining that the safeguarded space is not free of human, process 900 proceeds to 940 at which further sensor data is obtained. The further sensor data may comprise sensor data for a first field of detection and sensor data for a second field of detection. Process 900 iterates over 935-940 until the system determines that the safeguarded space is free of humans. In response to determining that the safeguarded space is free of humans, process 900 proceeds to 945.

At 945, the system causes the robot to resume autonomous operation.

At 950, a determination is made as to whether process 900 is complete. In some embodiments, process 900 is determined to be complete in response to a determination that no further robotic systems are to be monitored/controlled, the robot has completed its set of tasks in autonomous operation, a user has stopped the robot operation, an administrator or other user indicates that process 900 is to be paused or stopped, etc. In response to a determination that process 900 is complete, process 900 ends. In response to a determination that process 900 is not complete, process 900 returns to 905.

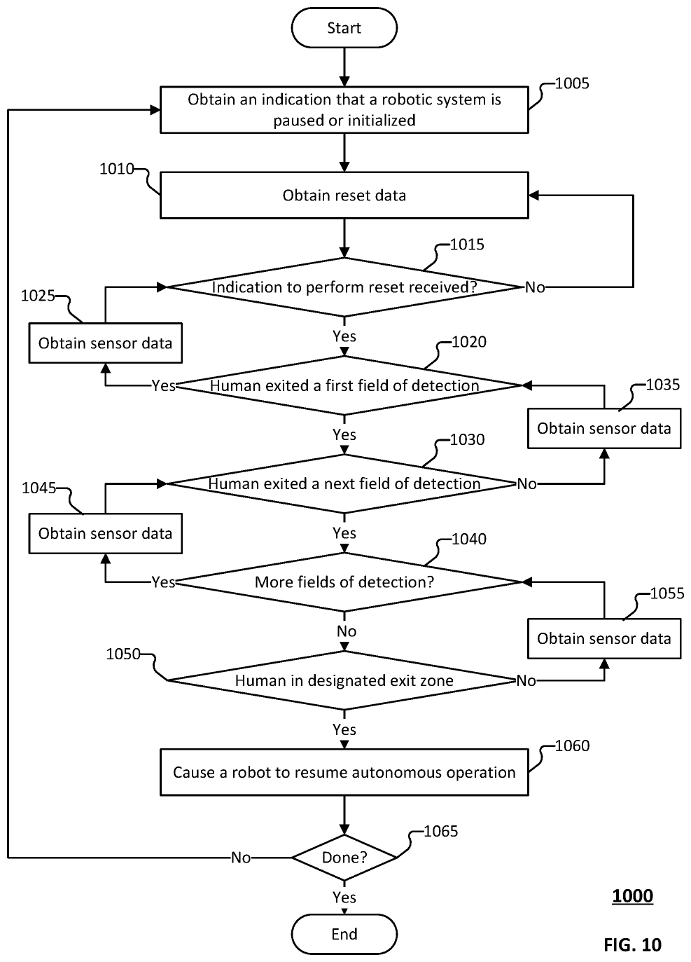

FIG. 10 is a flow diagram for controlling a robot to work in an autonomous mode according to various embodiments. In some embodiments, process 1000 is implemented at least in part by system 100 of FIG. 1 and/or system 400 of FIG. 4.

At 1005, the system obtains an indication that a robotic system is paused or initialized.

At 1010, the system obtains reset data. In some embodiments, the reset data comprises data indicating whether a reset control has been activated. For example, the reset data may be generated in response to a reset button being pressed, or other such reset control being activated. The system may monitor for a receipt of reset data.

At 1015, the system determines whether an indication to perform a reset is received. In some embodiments, the system determines whether a reset control has been activated. For example, the system determines whether a reset button (e.g., reset button 415 of system 400) within the safeguarded space is pressed.

In response to determining that the indication to perform the reset is not received at 1015, process 1000 returns to 1010 and process 1000 iterates over 1010-1015 until the system determines that the indication to perform the reset is received. Conversely, in response to determining that the indication to perform the reset is received, process 1000 proceeds to 1020.

At 1020, the system determines whether a human has exited a first field of detection. In some embodiments, the first field of detection corresponds to the field of detection closest to the robot. The system may have a plurality of successive detection fields. The successive detection fields are progressively further distanced from the robot.

In response to determining that the human has not exited the first field of detection, process 1000 proceeds to 1025 at which the system obtains sensor data, and process 1000 iterates over 1015-1020 until the system determines that the human has exited the first field of detection. Conversely, in response to determining that the human has exited the first field of detection, process 1000 proceeds to 1030.

At 1030, the system determines whether the human exited a next field of detection. In some embodiments, the next field corresponds to a field of detection adjacent to the first field of detection and further distanced from the robot.

In response to determining that the human has not exited the next field of detection, process 1000 proceeds to 1035 at which the system obtains sensor data, and process 1000 iterates over 1020-1030 until the system determines that the human has exited the next field of detection. Conversely, in response to determining that the human has exited the next field of detection, process 1000 proceeds to 1040.

At 1040, the system determines whether the system has another field of detection. For example, the system determines whether the successive fields of detection comprise another field of detection in the succession. As another example, the system whether the successive field of detection has a field of detection having a greater distance from the robot than the fields of detection from which the human previously exited.

In response to determining that the system has another field of detection(s), process 1000 proceeds to 1045 at which the system receives sensor data and process 1000 iterates over 1030-1040 until the system determines that no further field of detections exist. Conversely, in response to determining that the system determines that no further field of detections exist, process 1000 proceeds to 1050.

At 1050, the system determines whether the human is in a designated exit zone. The designated exit zone may be a predefined space according to which the system may safely resume autonomous operation when the human is located therein. For example, the designated exit zone is outside the safeguarded space.

In response to determining that the human is not in the designated exit zone, process 1000 proceeds to 1055 at which the system obtains sensor data. Thereafter, process 1000 returns to 1040 and process 1000 iterates over 1040-1050. Conversely, in response to determining that the human is in the designated exit zone, process 1000 proceeds to 1060.

At 1060, the system causes a robot to resume autonomous operation.

At 1065, a determination is made as to whether process 1000 is complete. In some embodiments, process 1000 is determined to be complete in response to a determination that no further robotic systems are to be monitored/controlled, the robot has completed its set of tasks in autonomous operation, a user has stopped the robot operation, an administrator or other user indicates that process 1000 is to be paused or stopped, etc. In response to a determination that process 1000 is complete, process 1000 ends. In response to a determination that process 1000 is not complete, process 1000 returns to 1005.

In various embodiments, techniques disclosed herein may be used to safely reset and resume autonomous operation by a robotic system, without (necessarily) having the ability to communicate with the robot from outside the safeguarded space.

While in some examples described herein safety scanner fields are used to detect and determine that the human worker who activated the reset button or other control has left the safeguarded space, in other examples other safety-rated structures and/or techniques may be used, such as successive light curtains, additional physically pressed or activated controls positioned in locations along the egress route, computer vision and associated logic, and/or other structures and techniques.

While in some examples a robotic system as disclosed herein is position in a shipping container, truck trailer, or other walled space, techniques disclosed herein may be used in other contexts, such as a cave, a shed, a recess, or other physically confined space.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a robot configured to move one or more items within a workspace;
a sensor configured to collect sensor data with respect to the workspace; and
one or more processors configured to:
determine to reset operation of the robot;
determine, based at least in part on the sensor data, that a human worker exited a safeguarded space within the workspace; and
in response to determining that the human worker exited the safeguarded space, resume operation of the robot.

2. The robotic system of claim 1, wherein the one or more processors are further configured to: pause operation of the robot in response to determining that an operator entered a safeguarded space within the workspace.

3. The system of claim 1, wherein the sensor comprises a first subset of sensors and a second subset of sensors having overlapping fields of detection.

4. The system of claim 1, wherein the sensor comprises a plurality of sensors that collect sensor data for different fields of detection in a set of fields of detection.

5. The system of claim 1, wherein:
the sensor comprises a first subset of sensors that capture sensor data for a first field of detection, and a second subset of sensors that capture sensor data for a second field of detection; and
the first field of detection and the second field of detection are at least partially overlapping.

6. The system of claim 1, wherein determining that the human worker exited a safeguarded space within the workspace comprises:
determining, based at least in part on the sensor data, that the human worker exited a set of fields of detection.

7. The system of claim 6, wherein:
the set of fields of detection are successive fields of detection; and
determining that the human worker exited the set of fields of detection includes determining that the human worker successively exited the successive fields of detection.

8. The system of claim 7, wherein determining that the human worker exited the set of fields of detection comprises:
determining that the human worker exited a first field of detection; and
in response to determining that the human worker exited the first field of detection, determining that the human worker exited a second field of detection, wherein the first field of detection is closer to the robot than the second field of detection.

9. The system of claim 1, wherein determining that the human worker exited a safeguarded space within the workspace comprises:
determining that the human worker entered a first field of detection;
determining that the human worker entered a second field of detection after entering the first field of detection;
determining that the human worker exited the first field of detection after the entering the second field of detection; and
determining that the human worker exited the second field of detection after the exiting the first field of detection.

10. The system of claim 9, wherein determining that the human worker entered the second field of detection comprises determining that the human worker moved from a back portion of the first field of detection to a front portion of the second field of detection.

11. The system of claim 9, wherein in response to determining that the human worker exited the second field of detection after the exiting the first field of detection, the robot is controlled to resume operation if no further humans are within the safeguarded space.

12. The system of claim 9, wherein the second field of detection is further from the robot than the first field of detection.

13. The system of claim 1, wherein operation of the robot is resumed after determining the human worker exited a last field of detection in a set of successive fields of detection without another operator entering the safeguarded space after the human worker exited a first field of detection.

14. The system of claim 1, wherein operation of the robot is resumed in response to determining the human worker is within a predefined designated exit zone that is disposed further from the robot than a last field of detection in a set of successive fields of detection.

15. The system of claim 1, wherein determining to reset the operation of the robot is based at least in part on a reset button within the workspace being activated before the human worker exits the safeguarded space.

16. The system of claim 15, wherein the button is on the robot or within a predefined distance of the robot.

17. The system of claim 1, wherein the one or more processors are further configured to perform image analysis with respect to the sensor data to detect a human within the workspace.

18. The system of claim 1, wherein at least a subset of the plurality of sensors operates with a refresh rate of 200 ms or less.

19. The system of claim 1, wherein the robot is resumed in response to determining that the human worker exited the safeguarded space without another human worker entering the safeguarded space before the robot resumes operation.

20. The system of claim 1, wherein the one or more processors are further configured to:
determine, based at least in part on the sensor data, that the human worker entered the safeguarded space while the robot is being controlled to move an item within the workspace; and
in response to determining that the human worker entered the safeguarded space, stopping operation of the robot.

21. The system of claim 1, wherein resuming operation of the robot includes controlling the robot to operate in an autonomous mode to move the items within the workspace.

22. The system of claim 1, wherein the robot comprises a robot comprising an end effector configured to grasp an item.

23. A method, comprising:
obtaining, from a sensor, sensor data with respect to a workspace for a robot configured to move one or more items;
determine to reset operation of the robot;
determine, based at least in part on the sensor data, that a human worker exited a safeguarded space within the workspace; and
in response to determining that the human worker exited the safeguarded space, resume operation of the robot.

24. A computer program product embodied in a non-transitory computer readable medium and comprising computer instructions for:
obtaining, from a sensor, sensor data with respect to a workspace for a robot configured to move one or more items;
determine to reset operation of the robot;
determine, based at least in part on the sensor data, that a human worker exited a safeguarded space within the workspace; and
in response to determining that the human worker exited the safeguarded space, resume operation of the robot.
